(19) United States
(12) Patent Application Publication
(10) Pub. No.: US 2025/0076608 A1
(43) Pub. Date: Mar. 6, 2025

(54) LENS DEVICE

(71) Applicants: Sintai Optical (Shenzhen) Co., Ltd., ShenZhen City (CN); Asia Optical Co., Inc., Taichung (TW)

(72) Inventors: Kazutaka Goami, Taichung (TW); Noriyuki Washio, Taichung (TW); Tomoyoshi Yano, Taichung (TW)

(21) Appl. No.: 18/790,003

(22) Filed: Jul. 31, 2024

(30) Foreign Application Priority Data
Aug. 28, 2023 (TW) 112132324

(51) Int. Cl. G02B 7/08; G02B 27/64

(52) U.S. Cl. CPC G02B 7/08; G02B 27/646

(57) ABSTRACT

A lens device includes a lens module, a base, a first carrier, a second carrier, a first driving coil, a second driving coil, a first driving magnet, a second driving magnet, and a flexible circuit board. The first carrier is movably disposed on the base for carrying the lens module. The second carrier is movably disposed on the base for carrying the first carrier. The first and second coils are fixedly disposed on the base. The first and second driving magnets are fixedly disposed on the second carrier. The flexible circuit board is disposed on the base, is electrically connected to the first and second driving coils, and includes a first portion and a second portion. The first portion is farther from the object side than the second portion. The first driving coil is disposed on the first portion. The second driving coil is disposed on the second portion.

### BACKGROUND OF THE INVENTION

### Field of the Invention

The invention relates to a lens device, and more particularly to a lens device with reduced thickness and good optical performance.

### Description of the Related Art

Nowadays, higher magnification or longer focal length lens devices is pursued, and the lens device correspondingly becomes larger in size. With the trend of miniaturization, the issue of reduction the thickness of an apparatus that is provided with a lens device, such as the camera devices of smart phones, tablets, mobile terminal devices, and micro-lens devices, has always been a concern and challenges for researchers.

### BRIEF SUMMARY OF THE INVENTION

The invention therefore provides a lens device, a thickness of which is reduced by way of reduction of thickness of a driving device installed therein.

The lens device in accordance with an exemplary embodiment of the invention includes a lens module, a base, a first carrier, a second carrier, a driving device and a power supplying element. The lens module includes an object side and an optical axis. The first carrier carries the lens module. The second carrier is disposed on the base to carry the first carrier, wherein the first carrier is movable with respect to the second carrier, and the second carrier is movable with respect to the base. The driving device includes at least one driving coil and at least one driving magnet corresponding to the driving coil, wherein the driving device is disposed between the lens module and the base, the driving coil is disposed on one of the base and the second carrier, and the driving magnet is disposed on the other of the base and the second carrier. The power supplying element is disposed between the base and the second carrier and electrically connected to the driving device. The lens module, the second carrier, the power supplying element and the base are sequentially arranged along the optical axis and in the lens device and the base is disposed farthest from the object side; alternatively, the lens module, the first carrier, the power supplying element and the base are sequentially arranged along the optical axis and in the lens device. The power supplying element includes a first portion and a second portion, the first portion is farther from the object side than the second portion in a direction along the optical axis, and the driving coil or the driving magnet of the driving device is disposed on the first portion and the second portion. The driving device is configured to drive the second carrier to move with respect to the base in a first axial direction and/or a second axial direction. The driving coil interacts with the driving magnet to generate an electromagnetic force that drives the second carrier to move in the first axial direction X and/or in the second axial direction. The first axial direction is perpendicular to the second axial direction.

In another exemplary embodiment, the power supplying element is a flexible circuit board.

In yet another exemplary embodiment, the first portion and the second portion are disposed to form a height difference on the flexible circuit board.

In another exemplary embodiment, the first portion and the second portion are disposed to form a plurality of height differences on the flexible circuit board.

In yet another exemplary embodiment, the first portion and the second portion are disposed to form a stair-like structure on the flexible circuit board.

In another exemplary embodiment, the stair-like structure includes a step.

In yet another exemplary embodiment, the stair-like structure includes a plurality of steps.

In another exemplary embodiment, the first portion is extended on a first plane, the second portion is extended on a second plane, the first plane and the second plane are perpendicular to the optical axis of the lens module, and the first plane and the second plane meet the optical axis of lens module at different intersections, the distance between which is greater than zero.

In yet another exemplary embodiment, the driving device further includes a first driving coil fixed to the base, a second driving coil fixed to the base, a first driving magnet fixed to the second carrier, and a second driving magnet fixed to the second carrier. The first driving coil interacts with the first driving magnet to generate an electromagnetic force that drives the second carrier to move in the first axial direction. The second driving coil interacts with the second driving magnet to generate an electromagnetic force that drives the second carrier to move in the second axial direction. The first carrier is further driven by the driving device to move with respect to the second carrier in a third axial direction. The third axial direction is perpendicular to the first axial direction and the second axial direction.

In another exemplary embodiment, the first driving coil is disposed on the first portion, and the second driving coil is disposed on the second portion.

In yet another exemplary embodiment, the driving device further includes a third driving coil and a third driving magnet. The third driving coil is fixed to the first carrier. The third driving magnet is fixed to the second carrier. The third driving coil interacts with the third driving magnet to generate an electromagnetic force that drives the first carrier to move in the third axial direction.

In another exemplary embodiment, the first portion includes a first installation zone. The second portion includes a second installation zone. The first driving coil is disposed on the first installation zone. The second driving coil is disposed on the second installation zone.

In yet another exemplary embodiment, the first driving magnet, the third driving coil and the third driving magnet are disposed in a space formed between the first portion and the second carrier. The second driving magnet is disposed in a space formed between the second portion and the second carrier.

In another exemplary embodiment, the first driving magnet and the third driving magnet are arranged in the third axial direction. The first driving magnet and the third driving magnet have a side in common, at which the third driving coil is disposed.

In yet another exemplary embodiment, an electric current of the first driving coil is configured to flow in the second axial direction. A N-pole of the first driving magnet is oriented at the first axial direction. An S-pole of the first driving magnet is oriented opposite to the N-pole.

In another exemplary embodiment, an electric current of the second driving coil is configured to flow in the first axial direction. A N-pole of the second driving magnet is oriented at the second axial direction. An S-pole of the second driving magnet is oriented opposite to the N-pole.

In yet another exemplary embodiment, an electric current of the third driving coil is configured to flow in the second axial direction. A N-pole and an S-pole of the third driving magnet are oriented at the first axial direction.

In another exemplary embodiment, the lens device further includes at least one flat resilient element and at least one linear resilient element. The flat resilient element connects the first carrier and the second carrier. The linear resilient element is extended in the third axial direction to connect the base and the flat resilient element. The linear resilient element is configured to further connect the base and the second carrier.

In yet another exemplary embodiment, the lens device further includes a guide element extended in the third axial direction and disposed between the first carrier and the second carrier for guiding the first carrier to move in the third axial direction.

In another exemplary embodiment, the first carrier includes outer surfaces on which a first recess is formed. The second carrier includes inner surfaces on which a second recess is formed. The first recess and the second recess are disposed corresponding to each other to contain the guide element.

### BRIEF DESCRIPTION OF THE DRAWINGS

FIG. 1 is a schematic view showing the structure of a lens device in accordance with an embodiment of the invention.

FIG. 2 is a sectional view of the lens device sectioned along II-II of FIG. 1.

FIG. 3 is a schematic view showing the structure of the lens module and the supporting structure of the lens device of FIG. 2.

FIG. 4 is an exploded view of the supporting structure of FIG. 3.

FIG. 5 is a schematic view of the driving device of the lens device of FIG. 2.

FIG. 6 depicts the principle of operation of the driving device of the lens device of FIG. 5 in the first axial direction.

FIG. 7 depicts the principle of operation of the driving device of the lens device of FIG. 5 in the second axial direction.

FIG. 8 depicts the principle of operation of the driving device of the lens device of FIG. 5 in the third axial direction.

### DETAILED DESCRIPTION OF THE INVENTION

The purpose, technical scheme and advantages of the invention can be more fully understood by reading the subsequent detailed description and examples with references made to the accompanying drawings. It is understood that this description is made for the purpose of illustrating the invention and should not be taken in a limiting sense.

In the following description, a first axial direction (or named X-axial direction) is a generic term that includes a first direction (+X direction) and the opposite direction (−X direction). A second axial direction (or named Y-axial direction) is a generic term that includes a second direction (+Y direction) and the opposite direction (−Y direction). A third axial direction (or named Z-axial direction) is a generic term that includes a third direction (+Z direction) and the opposite direction (−Z direction).

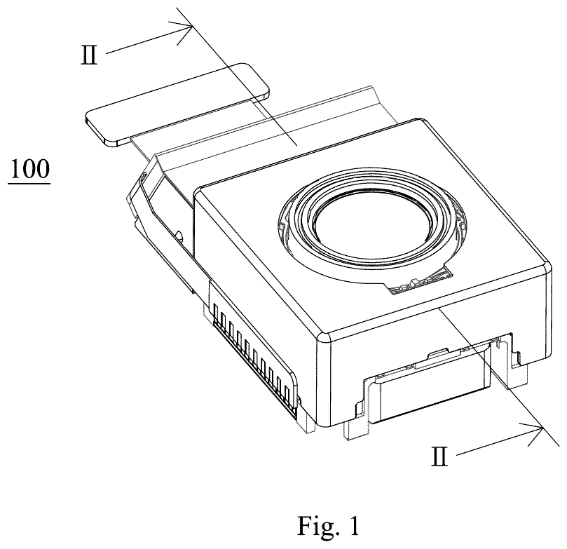

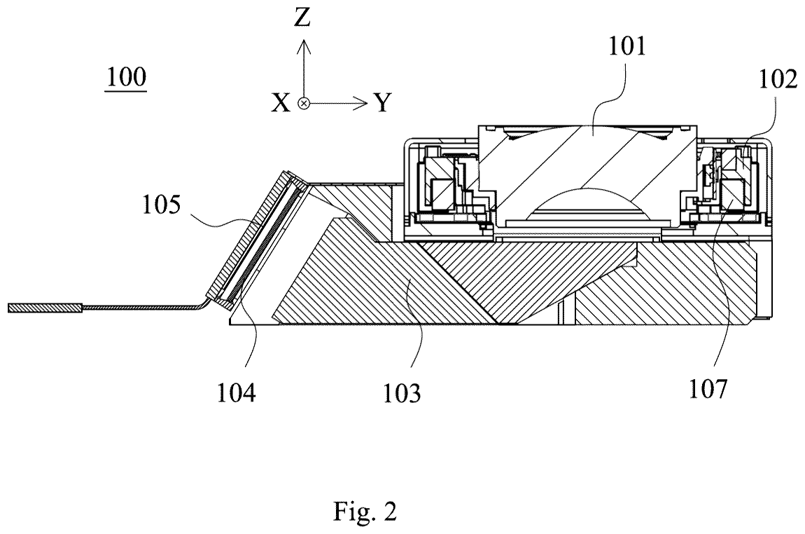

Referring to FIGS. 1 and 2, FIG. 1 is a schematic view showing the structure of a lens device 100 in accordance with an embodiment of the invention, and FIG. 2 is a sectional view of the lens device 100 sectioned along II-II of FIG. 1. As shown, the lens device 100 of this embodiment includes a lens module 101, a supporting structure 102, a driving device 107, a light path turning module 103, an optical filter 104 and an image sensor 105. In operation, light coming from the object side passes through the lens module 101, experiences multi-reflections in the light path turning module 103 to change the traveling direction, passes through the optical filter 104, and reaches the image sensor 105. The supporting structure 102 is provided for supporting the lens module 101 and the driving device 107. The driving device 107 is disposed between the lens module 101 and the supporting structure 102. The driving device 107 includes at least one driving coil and at least one driving magnet. The driving device 107 can drive the lens module 101 to move in the third axial direction (Z-axial direction) for performing auto focus (AF) operation. Further, the driving device 107 can drive the lens module 101 to move in the first axial direction (X-axial direction) and/or in the second axial direction (Y-axial direction) for performing optical image stabilization (OIS) operation.

In this embodiment, the light path turning module 103 includes one or more prisms, the optical filter 104 is an infrared ray (IR) cut filter, and the image sensor 105 is a charge-coupled device (CCD). The above elements are only examples for description and the invention is not limited thereto. Any other elements functioning the same should belong to the category of the invention. For example, the light path turning module 103 may be an integrally-formed continuous prism or may be composed of a plurality of prisms. Alternatively, the described prism(s) may be replaced with a reflecting mirror(s). Before reaching the image sensor 105, the light from the object side experiences multi-reflections in the light path turning module 103 so as to increase the optical path length. By such arrangement, the lens module 101 of the lens device 100 can be provided with an increased effective focal length (EFL) or an increased back focal length (BFL). Therefore, the lens device 100 can be miniaturized to be installed in a limited space and can still have good optical performance and higher optical magnification. The supporting structure 102 and the driving device 107 are described in detail in the following:

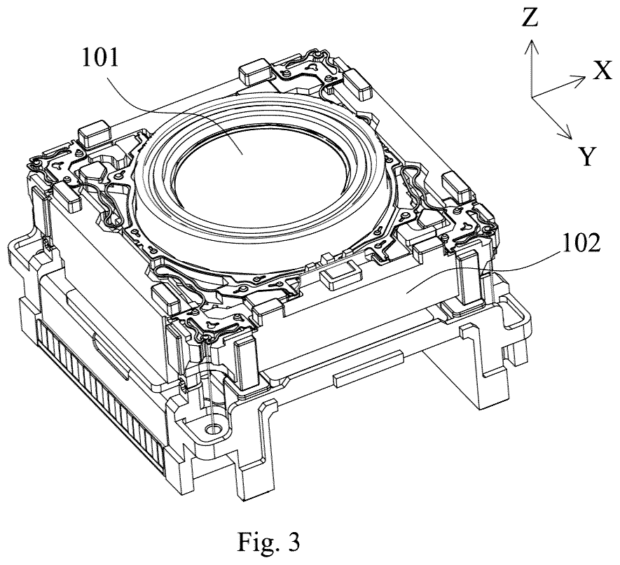

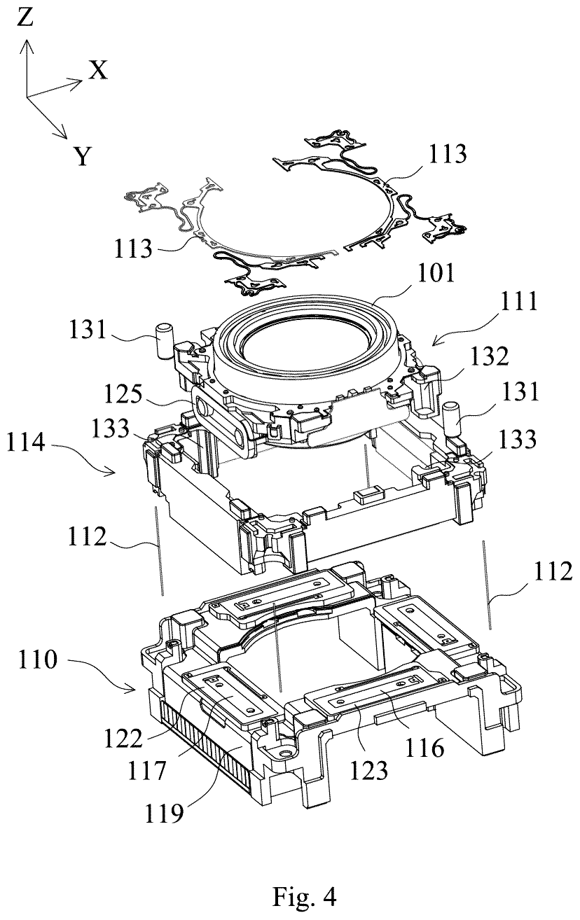

Referring to FIGS. 3 and 4, FIG. 3 is a schematic view showing the structure of the lens module 101 and the supporting structure 102 of the lens device 100 in accordance with this embodiment, and FIG. 4 is an exploded view of the supporting structure 102 of FIG. 3. As shown, the supporting structure 102 includes a base 110, a first carrier 111 and a second carrier 114. The first carrier 111 is disposed at the outer periphery of the lens module 101 to carry the lens module 101. The second carrier 114 is disposed at the outer periphery of the first carrier 111 to carry the first carrier 111. The base 110 is disposed under the first carrier 111 and the second carrier 114 for carrying the first carrier 111 and the second carrier 114.

The supporting structure 102 further includes a plurality of flat resilient elements 113 and linear resilient elements 112. The flat resilient elements 113 are windingly extended on the XY-plane and connected to the first carrier 111 and the second carrier 114. When the first carrier 111 is moved with respect to the second carrier 114 in the third axial direction Z under an external force (for example, an electromagnetic force from the driving device 107), the flat resilient element 113 is deformed and distorted thereby generating a resilient force against the first carrier 111 in a direction opposite to the third axial direction Z. When the external force acting on the first carrier 111 is reduced or removed, the first carrier 111 is moved back to the initial position in the direction opposite to the third axial direction Z under the resilient force of the flat resilient element 113, wherein the return of the first carrier 111 requires no power consumption. The first carrier 111 can be stably kept in position in the second carrier 114 by the flat resilient element 113 when the lens device 100 is out of operation without power supplied. The flat resilient element 113 has a winding portion (not labeled with any reference numeral). When the lens device 100 is under external impacts because of, for example, dropping or collision, the winding portion can provide a buffering effect to protect the flat resilient element 113 under excessive tensioning forces or stretching forces from damage or fracture. By such structural arrangement, the reliability of the lens device 100 can be promoted. The linear resilient elements 112 are extended in the Z-axial direction to connect the base 110 and the flat resilient elements 113, namely the linear resilient elements 112 are connected between the base 110 and the second carrier 114. When the second carrier 114 is moved with respect to the base 110 in the first axial direction X and/or the second axial direction Y under an external force (for example, an electromagnetic force from the driving device 107), the linear resilient element 112 is laterally bent thereby generating a resilient force against the second carrier 114 in a direction(s) opposite to the first axial direction X and/or the second axial direction Y. When the external force acting on the second carrier 114 is reduced or removed, the second carrier 114 is moved back to the initial position in the direction(s) opposite to the first axial direction X and/or the second axial direction Y under the resilient force of the linear resilient element 112, wherein the return of the second carrier 114 requires no power consumption. Further, the second carrier 114 can be stably kept in position in the base 110 by the linear resilient element 112 when the lens device 100 is out of operation without power supplied. It is understood that the driving device 107 can drive the first carrier 111 to move with respect to the second carrier 114 in the third axial direction (Z-axial direction) for performing auto focus (AF) operation and can drive the second carrier 114 to move with respect to the base 110 to move in the first axial direction (X-axial direction) and/or the second axial direction (Y-axial direction) for performing optical image stabilization (OIS) operation. The first axial direction, the second axial direction and the third axial direction are perpendicular to each other.

The first carrier 111 is provided with first recesses 132 on its outer surfaces. The second carrier 114 is provided with second recesses 133 on its inner surfaces. The second recesses 133 are disposed corresponding to the first recesses 132. The supporting structure 102 further includes guide elements 131 extending in the third axial direction (Z-axial direction). The guide elements 131 are disposed between the first carrier 111 and the second carrier 114. Specifically, the guide elements 131 are disposed in the first recesses 132 and the second recesses 133. During movement of the first carrier 111 with respect to the second carrier 114, the guide elements 131 guide the first carrier 111 to move in the third axial direction (i.e. the direction in which the guide elements 131 are extended). That is, the guide elements 131 can avoid the possibility of movement of the first carrier 111 with respect to the second carrier 114 in other directions, thereby ensuring the stability of movement of the first carrier 111 during the auto focus (AF) operation.

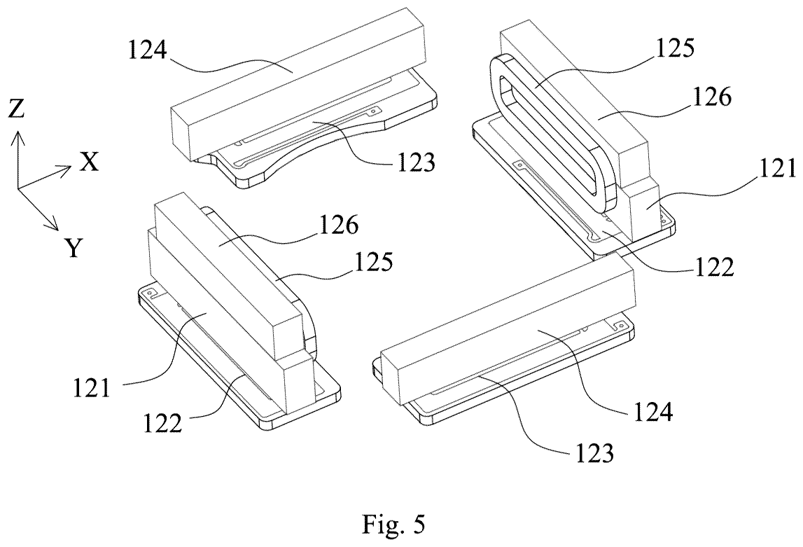

Referring to FIGS. 4 and 5, the driving device 107 includes a first driving coil 122, a first driving magnet 121, a second driving coil 123, a second driving magnet 124, a third driving coil 125 and a third driving magnet 126. A flexible circuit board 119 (or other power supplying elements) is provided on the base 110 for supplying power to the first driving coil 122, the second driving coil 123 and the third driving coil 125 of the driving device 107. Specifically, the flexible circuit board 119 is disposed on the base 110 and between the base 110 and the second carrier 114. The base 110 is a substantially rectangular frame. The flexible circuit board 119 has a shape corresponding to that of the base 110. Therefore, the flexible circuit board 119 has two opposite second portions in the X-axial direction and two opposite first portions in the Y-axial direction. As shown in FIG. 4, the optical axis of the lens module 101 is surrounded by the first portions and the second portions of the flexible circuit board 119. It is worth noting that the first portions are disposed lower than the second portions. The first portions and the second portions are disposed at different horizontal planes. The first portions are disposed farther from the object side of the lens module 101 than the second portions. In other words, the base 110 has height difference between high and low planes. The flexible circuit board 119 disposed on the base 110 also has height difference between high and low planes. The height difference between the first portion and the second portion is formed by a stair-like structure. In this embodiment, the stair-like structure has one step. However, the invention is not limited thereto. The height difference may be formed by a stair-like structure that has a plurality of steps. Specifically, the flexible circuit board 119 may further has a third portion, a fourth portion or more portions, and the height difference is formed by a stair-like structure that has two steps, three steps or more steps. Because of a stair-like structure that has at least one step, the invention is superior to the prior art in the space utilization and miniaturization of lens device when the space for containing elements is of the same height between the invention and the prior art. In this embodiment, the first portion is provided with a first installation zone 117 and the second portion is provided with a second installation zone 116, described in detail below.

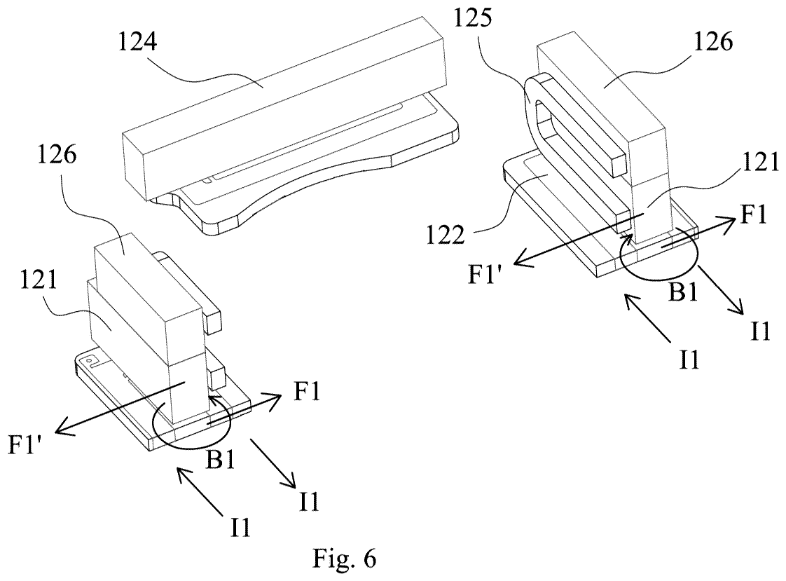

The first driving coil 122 is disposed in the first installation zone 117 of the flexible circuit board 119 to be connected to the flexible circuit board 119. The first installation zone 117 is farther from the object side of the lens module 101 than the second installation zone 116. Therefore, the first installation zone 117 is disposed lower than the second installation zone 116. The first installation zone 117 and the second installation zone 116 are disposed at different horizontal planes. The first installation zone 117 and the second installation zone 116 are disposed to form height difference between high and low planes. The first driving magnet 121 is firmly disposed at the bottom of the second carrier 114 and corresponding to the first driving coil 122. The first driving coil 122 interacts with the first driving magnet 121 to generate an electromagnetic force that drives the second carrier 114 to move in the first direction X or in the opposite direction. That is, the second carrier 114 is moved in the first axial direction (X-axial direction). Referring to FIG. 6, the first driving magnet 121 generates a magnetic field B1 in its surroundings, and the magnetic field lines pass through the first driving coil 122. When supplied with power by the flexible circuit board 119, the first driving coil 122 has an electric current I1 passing therethrough. Then, the first driving coil 122 sustains an electromagnetic force F1 according to the Fleming's Left Hand Rule. Also, the first driving magnet 121 sustains a reaction force F1′. The reaction force F1′ will drive the second carrier 114 to move because the first driving magnet 121 is fixed to the second carrier 114. When the electric current I1 of the first driving coil 122 is changed to flow in an opposite direction, the reaction force F1′ is correspondingly changed to act on the second carrier 114 in an opposite direction. Accordingly, the second carrier 114 can be moved in the first direction (+X direction) or in an opposite direction (−X direction), to counteract or compensate for the hand vibrations in the first axial direction (the X-axial direction).

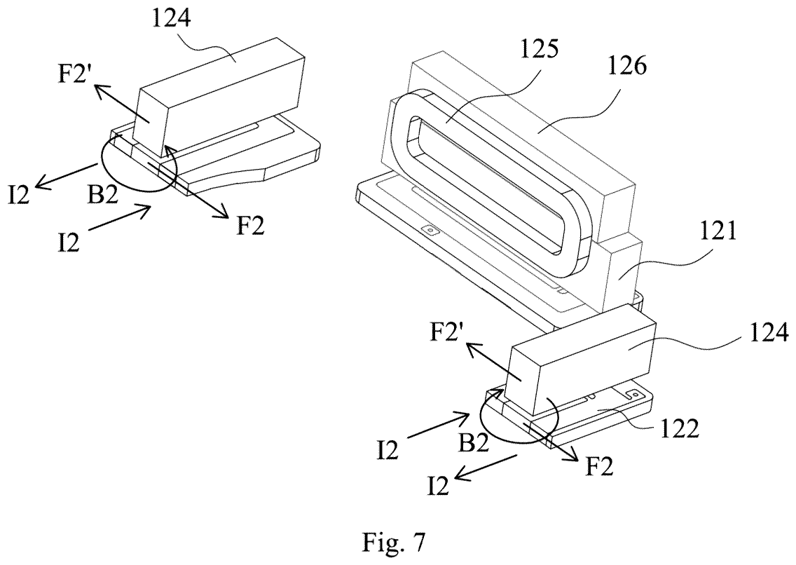

Similarly, the second driving coil 123 is disposed in the second installation zone 116 of the flexible circuit board 119 to be connected to the flexible circuit board 119. The second driving magnet 124 is firmly disposed at the bottom of the second carrier 114 and corresponding to the second driving coil 123. The second driving coil 123 interacts with the second driving magnet 124 to generate an electromagnetic force that drives the second carrier 114 to move in the second direction Y or in the opposite direction. That is, the second carrier 114 is moved in the second axial direction (Y-axial direction). Referring to FIG. 7, the second driving magnet 124 generates a magnetic field B2 in its surroundings, and the magnetic field lines pass through the second driving coil 123. When supplied with power by the flexible circuit board 119, the second driving coil 123 has an electric current I2 passing therethrough. Then, the second driving coil 123 sustains an electromagnetic force F2, and the second driving magnet 124 sustains a reaction force F2′. The reaction force F2′ will drive the second carrier 114 to move because the second driving magnet 124 is fixed to the second carrier 114. When the electric current I2 of the second driving coil 123 is changed to flow in an opposite direction, the reaction force F2′ is correspondingly changed to act on the second carrier 114 in an opposite direction. Accordingly, the second carrier 114 can be moved in the second direction (+Y direction) or in an opposite direction (−Y direction), to counteract or compensate for the hand vibrations in the second axial direction (the Y-axial direction).

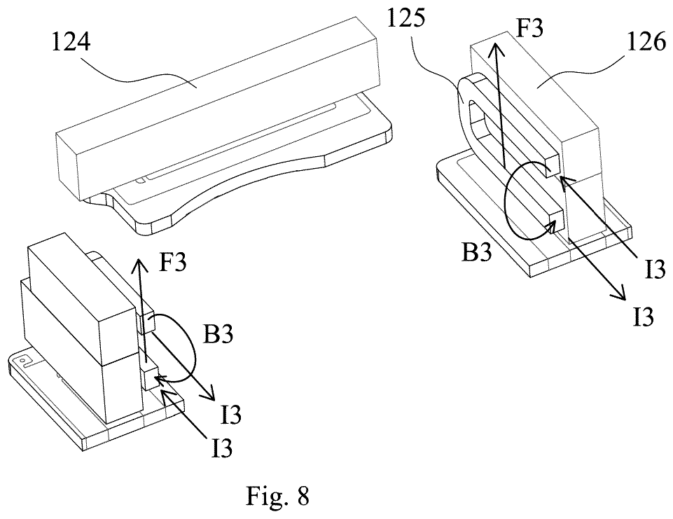

The third driving magnet 126 is laid on the first driving magnet 121 and also firmly disposed at the bottom of the second carrier 114. The third driving magnet 126 is disposed closer to the second carrier 114 than the first driving magnet 121 in the third axial direction (the Z-axial direction). The third driving coil 125 is firmly disposed on the first carrier 111 to be connected to the flexible circuit board 119 or a flexible circuit board (not shown) disposed on the first carrier 111. The third driving coil 125 is disposed corresponding to the third driving magnet 126 and the first driving magnet 121. As shown in FIG. 5, the third driving coil 125 is disposed at the same side of the first driving magnet 121 and the third driving magnet 126. The third driving coil 125 interacts with the third driving magnet 126 to generate an electromagnetic force that drives the first carrier 111 to move in the third direction Z or in the opposite direction. That is, the first carrier 111 is moved in the third axial direction (Z-axial direction). Referring to FIG. 8, the third driving magnet 126 generates a magnetic field B3 in its surroundings, and the magnetic field lines pass through the third driving coil 125. When supplied with power by the flexible circuit board 119, the third driving coil 125 has an electric current I3 passing therethrough. Then, the third driving coil 125 sustains an electromagnetic force F3. The electromagnetic force F3 will drive the first carrier 111 to move because the third driving coil 125 is fixed to the first carrier 111. When the electric current I3 of the third driving coil 125 is changed to flow in an opposite direction, the electromagnetic force F3 is correspondingly changed to act on the first carrier 111 in an opposite direction. Accordingly, the first carrier 111 can be moved in the third direction (+Z direction) or in an opposite direction (−Z direction), to perform an auto focus operation.

As described above, the first carrier 111 is disposed at the outer periphery of the lens module 101 for carrying the lens module 101. The second carrier 114 is disposed at the outer periphery of the first carrier 111 for carrying the first carrier 111. The base 110 is disposed below the first carrier 111 and the second carrier 114 for carrying the first carrier 111 and the second carrier 114. The flexible circuit board 119 is disposed between the base 110 and the second carrier 114. In the lens device 100, therefore, the lens module 101, the second carrier 114 (or the first carrier 111), the flexible circuit board 119 and the base 110 are sequentially arranged along the optical axis, wherein the base 110 is farthest from the object side. The first portion (the first installation zone 117) of the flexible circuit board 119 is disposed lower than the second portion (the second installation zone 116). That is, the first portion (the first installation zone 117) is disposed farther from the object side than the second portion (the second installation zone 116). In the invention, therefore, a space is formed above the first portion (the first installation zone 117) for installing the first driving magnet 121, the third driving magnet 126 and the third driving coil 125. As compared to that of the prior art, the lens device 100 of the invention has a reduced thickness.

Referring to FIG. 4, structurally, the first portion (the first installation zone 117) is disposed lower than the second portion (the second installation zone 116). That is, in the structural design, the flexible circuit board 119 is provided with height difference wherein the first portion (the first installation zone 117) and the second portion (the second installation zone 116) are disposed at different heights. In other words, the flexible circuit board 119 according to the structural design has a stair-like structure, wherein the first portion (the first installation zone 117) and the second portion (the second installation zone 116) are disposed at different steps. The arrangement of this embodiment can be described in different ways. For example, the first portion (the first installation zone 117) is extended on a first plane (not labeled) and the second portion (the second installation zone 116) is extended on a second plane (not labeled) wherein the first plane and the second plane are perpendicular to the optical axis of lens module 101. Further, the first plane and the second plane meet the optical axis of lens module 101 at different intersections, the distance between which is greater than zero. In sum, the structure of this embodiment has an additional space, without increasing thickness of the lens device 100, to install the first driving magnet 121, the third driving magnet 126 and the third driving coil 125. As compared to that of the prior art, the lens device 100 of the invention has a reduced thickness. Further, in this embodiment, the base 110 or the flexible circuit board 119 is provided with height difference or has a stair-like structure. However, the invention is not limited thereto. In some other embodiments, the height difference or stair-like structure can be provided on the bottom of the second carrier 114, and the arrangement of the elements of the driving device 107 are correspondingly changed. For example, the driving coils are changed to be disposed at the bottom of the second carrier 114 and the driving magnets are changed to be disposed on the base 110. In other words, the driving coils can be disposed on one of the base and the second carrier, while the driving magnets can be disposed on the other of the base and the second carrier.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A lens device, comprising:
a lens module comprising an object side and an optical axis;
a base;
a first carrier carrying the lens module;
a second carrier disposed on the base to carry the first carrier, wherein the first carrier is movable with respect to the second carrier, and the second carrier is movable with respect to the base;
a driving device comprising at least one driving coil and at least one driving magnet corresponding to the driving coil, wherein the driving device is disposed between the lens module and the base, the driving coil is disposed on one of the base and the second carrier, and the driving magnet is disposed on the other of the base and the second carrier;
a power supplying element disposed between the base and the second carrier and electrically connected to the driving device;
wherein the lens module, the second carrier, the power supplying element and the base are sequentially arranged along the optical axis and in the lens device and the base is disposed farthest from the object side;
alternatively, the lens module, the first carrier, the power supplying element and the base are sequentially arranged along the optical axis and in the lens device;
wherein the power supplying element comprises a first portion and a second portion, the first portion is farther from the object side than the second portion in a direction along the optical axis, and the driving coil or the driving magnet of the driving device is disposed on the first portion and the second portion;
wherein the driving device is configured to drive the second carrier to move with respect to the base in a first axial direction and/or a second axial direction;
wherein the driving coil interacts with the driving magnet to generate an electromagnetic force that drives the second carrier to move in the first axial direction X and/or in the second axial direction;
wherein the first axial direction is perpendicular to the second axial direction.

2. The lens device as claimed in claim 1, wherein the power supplying element is a flexible circuit board.

3. The lens device as claimed in claim 2, wherein the first portion and the second portion are disposed to form a height difference on the flexible circuit board.

4. The lens device as claimed in claim 2, wherein the first portion and the second portion are disposed to form a plurality of height differences on the flexible circuit board.

5. The lens device as claimed in claim 2, wherein the first portion and the second portion are disposed to form a stair-like structure on the flexible circuit board.

6. The lens device as claimed in claim 5, wherein the stair-like structure comprises a step.

7. The lens device as claimed in claim 5, wherein the stair-like structure comprises a plurality of steps.

8. The lens device as claimed in claim 1, wherein the first portion is extended on a first plane, the second portion is extended on a second plane, the first plane and the second plane are perpendicular to the optical axis of the lens module, and the first plane and the second plane meet the optical axis of lens module at different intersections, the distance between which is greater than zero.

9. The lens device as claimed in claim 1, wherein:
the driving device further comprises a first driving coil fixed to the base, a second driving coil fixed to the base, a first driving magnet fixed to the second carrier, and a second driving magnet fixed to the second carrier;
the first driving coil interacts with the first driving magnet to generate an electromagnetic force that drives the second carrier to move in the first axial direction;
the second driving coil interacts with the second driving magnet to generate an electromagnetic force that drives the second carrier to move in the second axial direction;
the first carrier is further driven by the driving device to move with respect to the second carrier in a third axial direction;
the third axial direction is perpendicular to the first axial direction and the second axial direction.

10. The lens device as claimed in claim 9, wherein the first driving coil is disposed on the first portion, and the second driving coil is disposed on the second portion.

11. The lens device as claimed in claim 9, wherein:
the driving device further comprises a third driving coil and a third driving magnet;
the third driving coil is fixed to the first carrier;
the third driving magnet is fixed to the second carrier;
the third driving coil interacts with the third driving magnet to generate an electromagnetic force that drives the first carrier to move in the third axial direction.

12. The lens device as claimed in claim 11, wherein:
the first portion comprises a first installation zone;
the second portion comprises a second installation zone;
the first driving coil is disposed on the first installation zone;
the second driving coil is disposed on the second installation zone.

13. The lens device as claimed in claim 11, wherein:
the first driving magnet, the third driving coil and the third driving magnet are disposed in a space formed between the first portion and the second carrier;
the second driving magnet is disposed in a space formed between the second portion and the second carrier.

14. The lens device as claimed in claim 13, wherein:
the first driving magnet and the third driving magnet are arranged in the third axial direction;
the first driving magnet and the third driving magnet have a side in common, at which the third driving coil is disposed.

15. The lens device as claimed in claim 11, wherein:
an electric current of the first driving coil is configured to flow in the second axial direction;
a N-pole of the first driving magnet is oriented at the first axial direction;
an S-pole of the first driving magnet is oriented opposite to the N-pole.

16. The lens device as claimed in claim 11, wherein:
an electric current of the second driving coil is configured to flow in the first axial direction;
a N-pole of the second driving magnet is oriented at the second axial direction;
an S-pole of the second driving magnet is oriented opposite to the N-pole.

17. The lens device as claimed in claim 11, wherein:
an electric current of the third driving coil is configured to flow in the second axial direction;
a N-pole and an S-pole of the third driving magnet are oriented at the first axial direction.

18. The lens device as claimed in claim 9, further comprising:
at least one flat resilient element;
at least one linear resilient element;
wherein the flat resilient element connects the first carrier and the second carrier;
wherein the linear resilient element is extended in the third axial direction to connect the base and the flat resilient element;
the linear resilient element is configured to further connect the base and the second carrier.

19. The lens device as claimed in claim 9, further comprising a guide element extended in the third axial direction and disposed between the first carrier and the second carrier for guiding the first carrier to move in the third axial direction.

20. The lens device as claimed in claim 19, wherein:
the first carrier comprises outer surfaces on which a first recess is formed;
the second carrier comprises inner surfaces on which a second recess is formed;
the first recess and the second recess are disposed corresponding to each other to contain the guide element.
